(19) United States
(12) Patent Application Publication
(10) Pub. No.: US 2008/0040027 A1
(43) Pub. Date: Feb. 14, 2008

(54) Trip Tracker

(76) Inventor: Val Brooks-Kennedy, Show Low, AZ (US)

Correspondence Address: JAMES RAY & ASSOCIATES, 2640 PITCAIRN ROAD, MONROEVILLE, PA, 15146, US

(21) Appl. No.: 11/890,756

(22) Filed: Aug. 7, 2007

Related U.S. Application Data
(60) Provisional application No. 60/821,866, filed on Aug. 9, 2006.

(51) Int. Cl. G01C 21/00

(52) U.S. Cl. 701/202

(57) ABSTRACT

A trip tracker for illustrating distance and time relationships. The trip tracker having a housing manufactured from a first predetermined material and having a first predetermined size and first predetermined shape. The trip tracker depicts an image of a predetermined travel route and includes indicia formed on the housing. The indicia illustrating predetermined information relating to a particular trip. An indicator mechanism is disposed on the housing for indicating various locations on the predetermined travel route at various times.

### CROSS REFERENCE TO RELATED APPLICATION

This patent application is related to and claims priority from U.S. Provisional Patent Application Ser. No. 60/821,866 filed Aug. 9, 2006.

### FIELD OF THE INVENTION

The present invention relates, in general, to clocks and timing devices and, more particularly, this invention relates to clocks and timing devices designed for use by children when taking a trip.

### BACKGROUND OF THE INVENTION

Prior to the conception and development of the present invention, clocks and timing devices, as are generally well known in the prior art, have been used to measure amounts of time.

Specifically of interest to the present invention are the following: Stankoulov, U.S. Pat. No. 7,043,357 discloses a computer-assisted navigation system. Garmin eMAP, available on the internet at www.garmin.com, discloses a system whereby a user accesses a computer program which directs the user along on a predetermined travel route to the user's destination. Vacation Memory Book, available on the internet at www.EnchantedLearning.com, discloses a printable activity book for use by a child while on a long car trip.

### SUMMARY OF THE INVENTION

The present invention provides a trip tracker for illustrating distance and time relationships. This trip tracker comprises a housing manufactured from a first predetermined material and having a first predetermined size and first predetermined shape. The housing depicts an image of a predetermined travel route thereon. Indicia are formed on the housing illustrating predetermined information relating to a trip. An indicator means is disposed on the housing for indicating various locations on the predetermined travel route at various times.

### OBJECTS OF THE INVENTION

It is, therefore, one of the primary objects of the present invention to provide a Trip Tracker for use by a child to help the child understand the concept of distance and time relationships.

Another object of the present invention is to provide a tangible object to be held by a child that will allow the child to gauge how long it has been since the child departed on the child's trip and how much longer it will be before the final destination is reached.

Still another object of the present invention is to provide a device for demonstrating the passage of time during a trip to children.

Yet another object of the present invention is to provide a teaching apparatus for use by parents to aid in teaching a child to correlate time passed with distance traveled.

An additional object of the present invention is to provide a fun and colorful accessory for a child to play with while on a trip.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the trip tracker according to one embodiment of the invention.

FIG. 2 is a partial perspective view of the trip tracker according to one embodiment of the invention.

FIG. 3 is a partial perspective view of the trip tracker according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

Reference is now made, more particularly, to FIGS. 1-3. According to a first embodiment of the invention, a trip tracker, generally designated 9, is illustrated in FIGS. 1-3. The trip tracker includes a housing, generally designated 10, manufactured from a first predetermined material. In the presently preferred embodiment of the invention, the first predetermined material will be selected from the group consisting of metal, plastic, and fabric, or from the group consisting of cardboard, wood and fiber.

The housing 10 has a first predetermined size and first predetermined shape. In the presently preferred embodiment it is most preferred that the first predetermined shape is a circle, generally designated 11.

The housing depicts an image of a predetermined travel route, generally designated 12.

Indicia, generally designated 14, are formed on such housing 10 illustrating predetermined information relating to a particular trip. In the presently preferred embodiment of the invention, such indicia 14, represents at least one of a starting point 16 at a beginning of the predetermined travel route 12, and a final destination 18 at an end of the predetermined travel route 12. It is most preferred that the indicia 14 of a starting point is a house 19.

An indicator means, generally designated 17, is disposed on such housing 10, for indicating various locations on the predetermined travel route 12 at various times. In the presently preferred embodiment of the invention, the indicator means 17 indicates at least one of distance traveled and time passed and time remaining prior to reaching a predetermined point on the predetermined travel route 12.

In the presently preferred embodiment of the invention, the indicator means 17 is a rotateable arm member 20, having a second predetermined shape, and size, and manufactured from a second predetermined material. Such rotateable arm member 20 is operably connected to the housing 10.

In the presently preferred embodiment of the invention, the second predetermined material is selected from the group consisting of metal, plastic, and fabric or from the group consisting of cardboard, wood, and fiber.

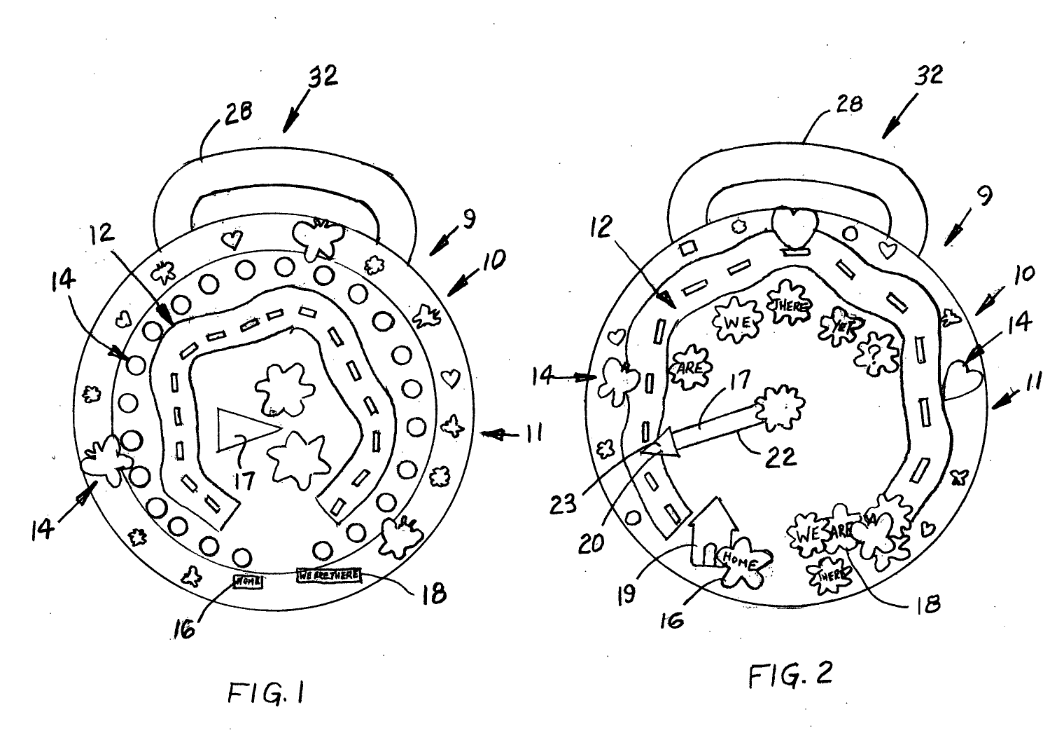

In the presently preferred embodiment of the invention, as shown in FIGS. 1-2, the shape of the rotateable arm member 20 is an arrow 22 with the head 23 of the arrow 22 disposed at a predetermined end thereof.

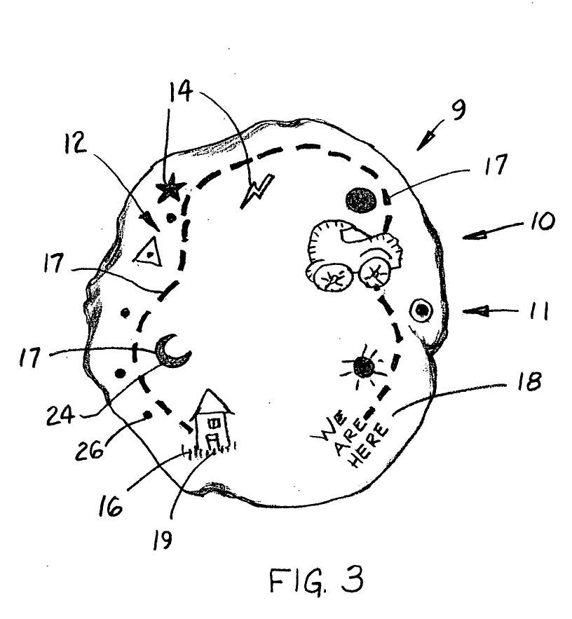

According to another embodiment of the invention, as shown in FIG. 3, the indicator means 17 is at least one of pictorial images 24 and markings 26 disposed along a side of the image of such predetermined travel route 12.

In yet another embodiment, a handle member 28 having a third predetermined shape and size and manufactured from a third predetermined material is attached to an upper surface adjacent an outer edge of the housing 10. In this embodiment it is most preferred that the third predetermined shape is an arc, generally designated 32. In this embodiment of the invention, it is preferred that the third predetermined material is selected from the group consisting of metal, plastic and fabric or from the group consisting of cardboard, wood and fiber.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A trip tracker for illustrating distance and time relationships, said trip tracker comprising;
a. a housing manufactured from a first predetermined material and having a first predetermined size and a first predetermined shape and depicting an image of a predetermined travel route;
b. indicia formed on said housing illustrating predetermined information relating to a particular trip; and
c. an indicator means disposed on said housing for indicating various locations on said predetermined travel route at various times.

2. A trip tracker, according to claim 1, wherein said indicia represents at least one of a starting point at a beginning of said predetermined travel route and a final destination at an end of said predetermined travel route.

3. A trip tracker, according to claim 1, wherein said indicator means indicates at least one of distance traveled and time passed and time remaining prior to reaching a predetermined point on said predetermined travel route.

4. A trip tracker, according to claim 1, wherein said indicia of a starting point is a house.

5. A trip tracker, according to claim 1 wherein said first predetermined material is selected from the group consisting of metal, plastic and fabric.

6. A trip tracker, according to claim 1 wherein said first predetermined material is selected from the group consisting of cardboard, wood and fiber.

7. A trip tracker, according to claim 1 wherein said indicator means is a rotateable arm member, having a second predetermined shape and size and manufactured from a second predetermined material, operably connected to said housing.

8. A trip tracker, according to claim 9, wherein said second predetermined shape is an arrow with the head of said arrow at a predetermined end thereof.

9. A trip tracker, according to claim 1, wherein said indicator means is at least one of pictorial images and markings along a side of said image of said predetermined travel route.

10. A trip tracker, according to claim 1, wherein said trip tracker further includes a handle member having a third predetermined shape and size and manufactured from a third predetermined material attached to an upper surface adjacent an outer edge of said housing, said handle member manufactured from a third predetermined material.

11. A trip tracker, according to claim 1, wherein said first predetermined shape is a circle.

12. A trip tracker, according to claim 7, wherein said second predetermined material is selected from the group consisting of metal, plastic and fabric.

13. A trip tracker, according to claim 7, wherein said first predetermined material is selected from the group consisting of cardboard, wood and fiber.

14. A trip tracker according to claim 10 wherein said third predetermined material is selected from the group consisting of metal, plastic and fabric.

15. A trip tracker according to claim 10 wherein said third predetermined material is selected from the group consisting of cardboard, wood and fiber.

16. A trip tracker according to claim 10 wherein the third predetermined shape is an arc.
